(19) United States
(12) Patent Application Publication
(10) Pub. No.: US 2006/0018740 A1
(43) Pub. Date: Jan. 26, 2006

(54) Apparatus for retrieving golf balls from under water locations

(76) Inventor: Cote' A. Blythe, Hendersonville, NC (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/186,362

(22) Filed: Jul. 21, 2005

Related U.S. Application Data
(60) Provisional application No. 60/590,217, filed on Jul. 21, 2004.

(51) Int. Cl. B60P 1/00

(52) U.S. Cl. 414/440

(57) ABSTRACT

A golf ball retrieval machine includes an axle, a plurality of generally circular discs disposed on the axle, the discs being slightly flexible in a transverse direction near a peripheral edge of each disc, and a plurality of rods extending through the discs to maintain the discs in a spaced-apart relationship. A handle is secured to the axle to pull the golf ball retrieval machine underwater to retrieve golf balls from bottom of the water between the rotating discs. Sleeves are disposed on each of the rods between pairs of adjacent discs to maintain the spacing between adjacent discs slightly less than the diameter of a golf ball. The machine may be pulled underwater by a boat.

### CROSS-REFERENCE TO RELATED PATENT APPLICATION

This patent application is a non-provisional patent application of U.S. provisional patent application Ser. No. 60/590,217, filed on Jul. 21, 2004, the right of priority of which is hereby claimed for this patent application.

### FIELD OF THE INVENTION

The present invention relates generally to apparatus for retrieving golf balls. More particularly, the invention relates to apparatus for retrieving golf balls that are lost, especially in water hazards on golf courses.

### BACKGROUND OF THE INVENTION

To make the sport of golf more interesting and challenging, golf courses usually include various types of water hazards. For example, such water hazards may be streams or ponds in the golf course, or a portion of the golf course may be located along a river, a lake or a seacoast. If a golf ball errantly enters such a water hazard, it may sometimes be close enough to a bank, or the like, that it can be retrieved by hand or by an extendible retrieving tool. However, many golf balls that enter water hazards are in deeper water, where they typically cannot be seen, or where they cannot be reached with an extendible retrieval tool.

Golf ball retrieval machines for retrieving golf balls at driving ranges are known to the art. Typically, these retrieval machines have a heavy frame that may be attached to a tractor for pulling the machine behind the tractor. Multiple gangs, each consisting of a plurality of spaced-apart discs, are rotatably supported by the frame. Wheels are attached to the frame to support the gangs of spaced-apart discs at near ground level. Such machines typically weigh hundreds of pounds and are about 12 to 20 feet, or more, wide.

Thus, while suitable for retrieving golf balls on relatively flat grassy surfaces, these prior art machines are too wide to be used in many water hazards on golf courses. They would also be ineffective at removing golf balls from the typically irregular bottoms of water hazards. Moreover, the weight of such machines makes their underwater use impractical because they are likely to get submerged and stuck in the muddy bottoms of many water hazards or catch against underwater stumps, boulders or the like.

While many golf balls are affordably priced, certain brands are often more expensive. Thus, while it is generally not worthwhile to retrieve a single golf ball from a water hazard, it is usually worthwhile when a significant number of golf balls accumulate in the water. Heretofore, a commonly employed means of retrieving golf balls from otherwise inaccessible underwater locations was by diving.

There has been a long-felt need for apparatus that can effectively retrieve golf balls from the bottoms of water hazards without the need of employing a diver.

A general object of the present invention is therefore to provide apparatus for retrieving golf balls from the bottoms of water hazards.

Another object of the present invention is to provide apparatus for retrieving golf balls from the bottoms of water hazards that may be pulled by a boat or the like.

Yet another object of the present invention is to provide apparatus for retrieving golf balls from underwater sites that is sufficiently light to be easily moved or transported, such as by a human, but yet sufficiently heavy to keep it on the bottom of the water body to retrieve balls.

### SUMMARY OF THE INVENTION

The present invention is directed to a golf ball retrieval machine for retrieving golf balls from underwater sites. The golf ball retrieval machine includes an axle with first and second ends, a plurality of generally circular discs disposed on the axle, the discs being slightly flexible in a transverse direction near a peripheral edge of each disc, a plurality of rods extending through the discs to maintain the discs in a spaced-apart relationship in which the spacing between adjacent discs is slightly less that the diameter of a golf ball and a handle secured to the first and second ends of the axle in a manner that permits rotation of the plurality of discs relative to the handle such that the handle may be used to pull the golf ball retrieval machine underwater to retrieve golf balls from bottom of the water. Preferably, sleeves are disposed on each of the rods between each pair of adjacent discs with the sleeves having a length slightly less than the diameter of a golf ball to maintain the spacing between adjacent discs at a like spacing.

The plurality of discs may be fabricated from a thermoplastic resin or from aluminum. The golf ball machine may include discs made from both thermoplastic resin and aluminum. The plurality of discs may include about 20 discs, with thickness of each disc being about 0.125 inches (0.32 cm) thick and the diameter of each disc being about 24 inches (61.0 cm). The peripheral edges of the plurality of discs penetrate into softer bottoms of the water to retrieve golf balls partially below, or completely below, the bottom surface.

A pair of arms is connected to a first end of the axle and to a second end of the axle, with opposite ends of the pair of arms also connected to the handle. Means for connecting the golf ball retrieval machine to a device and for pulling the machine through water is defined on the handle. These means may include a pair of eyelets disposed along the handle at spaced apart locations. The device for pulling the machine through water may be a boat.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the figures in which like reference numerals identify like elements, and in which:

FIG. 1 is a perspective view of a golf ball retrieval machine suitable for retrieving golf balls from the bottom of a body of water in accordance with the present invention;

FIG. 2 is an end view of the golf ball retrieval machine shown in FIG. 1 illustrating further details thereof;

FIG. 3 is a top plan view of the golf ball retrieval machine shown in FIGS. 1 and 2 illustrating further details thereof;

FIG. 4 is a perspective view of a portion of one of the rods that extends through the discs of the golf ball retrieval machine shown in FIGS. 1-3, also illustrating a spacer that is used on the rod between each pair of adjacent discs; and

FIG. 5 is a diagrammatic elevational view of a boat pulling the golf ball retrieval machine shown in FIGS. 1-3 through a body of water to retrieve golf balls from the bottom of the water.

### DESCRIPTION OF THE PREFERRED EMBODIMENT

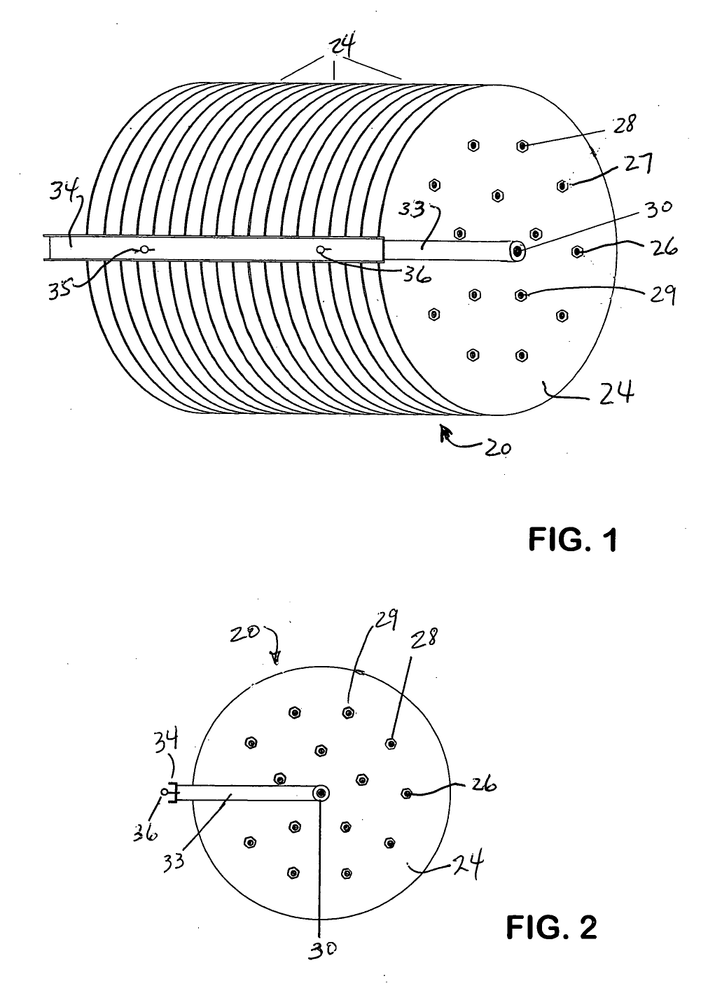

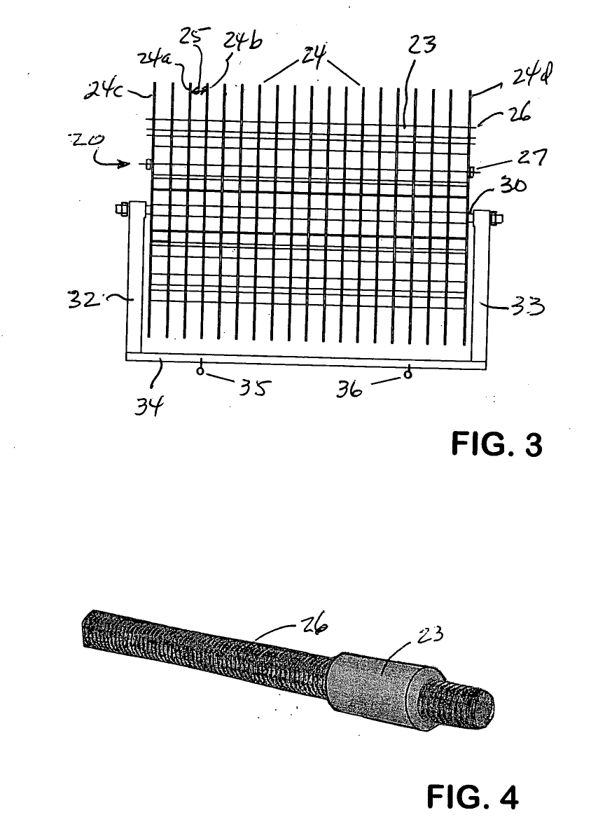

An example of a golf ball retrieval machine, generally designated 20, that is constructed in accordance with the present invention is shown in FIGS. 1-3. Machine 20 preferably utilizes a plurality of generally circular discs 24 that are held in spaced-apart relationship. The spacing 25 (FIG. 3) between any pair of adjacent disks 24a and 24b is slightly less than the diameter of a golf ball, such that a golf ball can be grasped between a pair of adjacently disposed discs. The typical diameter of a golf ball is about 1.68 inches (4.27 cm). Thus, when machine 20 rolls over a golf ball, the pair of discs 24a and 24b that encounter the golf ball tend to flex slightly apart in a transverse direction from each other to accommodate the golf ball between the discs near the perimeter of each disc. Thereafter, the golf ball is frictionally engaged and retained between the discs until it is removed.

The plurality of discs 24 may be of any suitable diameter, such as about 24 inches. Such a diameter permits the machine 20 to roll over smaller underwater stones, rocks, tree stumps and the like, without catching or hanging up on the same. Discs 24 may be fabricated from any suitable material such as thermoplastics or aluminum. For example, LEXAN® thermoplastic resins commercially available from GE Plastics of Pittsfield, Mass. may be used. LEXAN is a trademark of the General Electric Company. It may also be desirable to use a combination of disc types such as aluminum discs for the end discs 24c and 24d (FIG. 3) and thermoplastic discs internally between the end discs. This is because the end discs may be subjected to greater stresses while machine 20 is in use. End discs 24c and 24d also engage fasteners to hold the assembly of discs together, as further described below.

Typically, approximately 10 to 40 discs may be utilized in machine 20 and, preferably, about 20 discs. If 20 discs are used, the total width of a gang of 20 discs will generally be in the range of about 28 to 36 inches (77.2 cm to 91.4 cm), depending upon the thickness of each disc 24. For example, a typical thickness of a disc 24 may be about 0.125 inch (0.32 cm) and the spacing between the discs may be about 1.59 inches (3.34 cm). Thus, a machine 20 utilizing 20 discs and this spacing between the discs would be about 32.7 inches (83.1 cm) wide from end disc to end disc, not including that portion of axle 30 that extends out from each end disc.

The discs 24 are maintained in the spaced-apart relationship by a plurality of rods 26 (FIG. 3) that extend through the discs 24 at various radially disposed positions, such as at positions 28 and 29 (FIG. 2), which are also disposed inwardly from the perimeter of the discs. Machine 20, as illustrated in FIGS. 1-3, utilizes a total of 15 rods 26. However, the number of rods 26 utilized may vary depending on the diameter of the discs 24, the material of the discs and the thickness of the discs. The interior location of rods 26, in combination with the sleeves 23 utilized on the rods between each adjacent pair of discs 24, maintains the desired spacing between the discs while permitting sufficient transverse flexing of the peripheral edges of the discs to allow the discs to collect golf balls between the discs.

Rods 26 may be threaded at their ends to receive a threaded fastener 27 at the ends thereof. For example, a portion of one of rods 26 is shown in FIG. 4. Tubular spacer sleeves 23, of a length generally equal to the spacing 25 between adjacent discs 24a and 24b, may be placed over rods 26 to maintain the discs in the desired spacing 25. FIG. 4 shows one of the spacers 23 on a portion of a rod 26. For example, rod 26 may be 0.625 inch (1.58 cm) in diameter and spacers 23 may be fabricated from prime high density polyethylene (HDPE) tube. Spacers 23 can also be fabricated from metal. In this example, spacers 23 may have an internal diameter of 0.625 inch (1.58 cm), a wall thickness of 0.110 inch (0.28 cm) and a length of 1.592 inches (3.34 cm). As can be further appreciated, use of spacers 23 also assists in rapid assembly of the plurality of discs 24. If machine 20 is fabricated using the above representative sizes and materials for the various components, machine 20 will weigh about 80 pounds (36.4 kg). It will be appreciated that the weight of machine 20 can be reduced if, for example, smaller diameter rods 26 are used than the 0.626 inch diameter rods. Thus, machine 20 can be fabricated to weigh well under 100 pounds (45.5 kg) and can be easily manually moved from one location to another location by pulling the machine with handle 34.

An axle 30 extends axially through the center of each of the discs 24. Each end of axle 30 is mounted to an arm 32 and 33, respectively. Either axle 30 freely rotates in the ends of arms 32-33 or the plurality of discs 24 freely rotate about axle 30. A handle 34 is attached to opposite ends of arms 32 and 33 in a generally perpendicular manner and extends therebetween. Due to the lightness of machine 20, handle 34 may be used to manually carry the machine 20, as needed or desired.

Handle 34 also is equipped with a pair of eyebolts 35 and 36 disposed at spaced locations along the handle 34 to provide a connection for pulling machine 20 through water. Eyebolts 35-36 may be used to attach machine 30 to a boat, or the like, to pull machine 20 through water to retrieve golf balls as shown in FIG. 4. Of course, other means of connecting to handle 34 may be provided, such as apertures defined in the handle 34. Machine 20 could alternately be pulled along guide wires, or the like, such as by a winch. However, a winching system will typically require more time to set up.

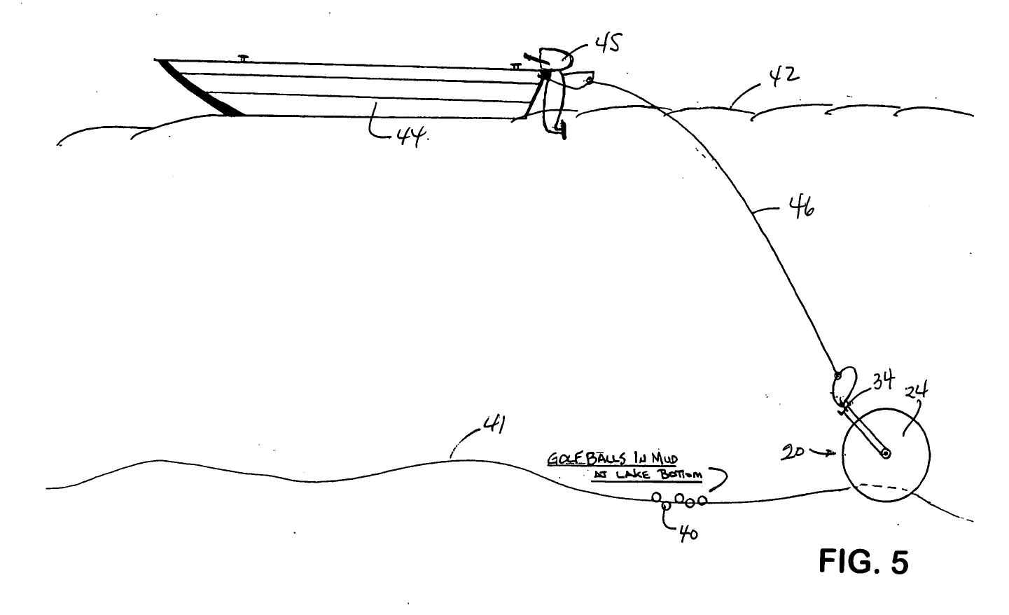

FIG. 5 illustrates machine 20 submerged in a body of water 42 to collect golf balls 40 from the bottom 41 of the body of water. As depicted in FIG. 5, the golf balls 40 may be on the surface of the bottom 41, or may be partially or wholly embedded below the surface of the bottom 41. Of course, if the bottom is firm, the golf balls are not likely to be wholly embedded in the bottom 41. However, if the bottom 41 is muddy, soft, or the like, some of the golf balls are likely to be at least partially embedded in the bottom 41. Because of the relative thinness of the discs 24 of machine 20, the weight of machine 20 will cause the peripheral edge of the discs 24 to penetrate into any softer surface of the bottom 41 to retrieve those golf balls 40 that are partially or wholly embedded therein.

In the example of FIG. 5, a boat 44 is powered by a motor 45. A rope or cable 46 is connected to the boat 45 at one end and to the handle 34 of machine 20 on the other end to move the machine 20 along the bottom 41 of the water 42 to retrieve the submerged golf balls 40.

As can be appreciated from the above, machine 20 is quite durable and can withstand rocks, stumps and other debris commonly found at the bottom of bodies of water. Similarly, such obstacles will not normally affect the overall performance of machine 20. Detachable weights may be added, such as to handle 34, to improve the ball retrieval efficiency of machine 20, such as where deeper penetration of the bottom 41 of the body of water 42 by the peripheral edges of discs 24 is needed or desired. Machine 20 is also corrosion resistant with the thermoplastic resin and aluminum discs 24. Similarly, other corrosion resistant components may be utilized, if desired, such as rods 26 that are plated and threaded fasteners that are of stainless steel, or the like.

While particular embodiments of the invention have been shown and described, it will be obvious to those skilled in the art that changes and modifications may be made therein without departing from the invention in its broader aspects.

1. A golf ball retrieval machine for retrieving golf balls from underwater sites, said golf ball retrieval machine comprising:
an axle, said axle having first and second ends;
a plurality of generally circular discs disposed on the axle, said discs being slightly flexible in a transverse direction near a peripheral edge of each disc;
a plurality of rods extending through the discs to maintain the discs in a spaced-apart relationship in which the spacing between adjacent discs is slightly less that the diameter of a golf ball; and
a handle, said handle secured to the first and second ends of the axle in a manner that permits rotation of the plurality of discs relative to the handle, said handle suitable for pulling the golf ball retrieval machine underwater to retrieve golf balls from bottom of the water.

2. The golf ball retrieval machine in accordance with claim 1, said golf ball retrieval machine further comprising:
a sleeve disposed on each of said rods between each pair of adjacent discs, said sleeves having a length slightly less than the diameter of a golf ball to maintain the spacing between adjacent discs at the same spacing as the length of each sleeve.

3. The golf ball retrieval machine in accordance with claim 1, wherein said plurality of discs are fabricated from a thermoplastic resin.

4. The golf ball retrieval machine in accordance with claim 1, wherein said plurality of discs are fabricated from aluminum.

5. The golf ball retrieval machine in accordance with claim 1, wherein some of said plurality of discs are fabricated from a thermoplastic resin and some of said plurality of discs are fabricated from aluminum.

6. The golf ball retrieval machine in accordance with claim 1, wherein said plurality of discs includes about 20 discs.

7. The golf ball retrieval machine in accordance with claim 1, wherein each of said plurality of discs is about 0.125 inches (0.32 cm) thick.

8. The golf ball retrieval machine in accordance with claim 1, wherein each of said plurality of discs is about 24 inches (61.0 cm) in diameter.

9. The golf ball retrieval machine in accordance with claim 1, said golf ball retrieval machine further comprising;
a pair of arms, one of said pair of arms connected to the first end of the axle and a second of said pair of arms connected to a second end of the axle, said pair of arms also each connected to the handle.

10. The golf ball retrieval machine in accordance with claim 1, said golf ball retrieval machine further comprising:
means for defined on said handle for connecting said golf ball retrieval machine to a device for pulling said machine through the water.

11. The golf ball retrieval machine in accordance with claim 10, said means for connecting said golf ball retrieval machine to a device and for pulling said machine through the water including a pair of eyelets, said pair of eyelets disposed along said handle at spaced apart locations.

12. The golf ball retrieval machine in accordance with claim 10, wherein said device for pulling the machine through water is a boat.

13. The golf ball retrieval machine in accordance with claim 1, wherein peripheral edges of the plurality of discs penetrate into a softer bottom surface to retrieve golf balls partially or completely below the bottom surface.

14. The golf ball retrieval machine in accordance with claim 1, wherein said machine weighs less than 100 pounds.
